(19) United States
(12) Patent Application Publication
(10) Pub. No.: US 2009/0233631 A1
(43) Pub. Date: Sep. 17, 2009

(54) System for reporting incidents using a text message

(76) Inventors: Alvin Butler, SR., Bowie, MD (US); Rebecca Butler, Bowie, MD (US)

Correspondence Address: Hoffman, Wasson & Gitler, P.C., 2461 South Clark Street, Suite 522, Arlington, VA, 22202, US

(21) Appl. No.: 12/382,320

(22) Filed: Mar. 13, 2009

Related U.S. Application Data
(60) Provisional application No. 61/064,579, filed on Mar. 13, 2008.

(51) Int. Cl. H04W 4/00

(52) U.S. Cl. 455/466

(57) ABSTRACT

A process and system used for reporting and processing incidents of aggressive, dangerous, and discourteous drivers using Short Message Service (SMS) data, also known as “text messaging” using key words or characters. A hand held electronic device is used to send a text message location reporting emergency or non-emergency information to a central processing unit. By establishing a process and system that utilizes mobile hand held electronic devices or cell phones to report emergency and non-emergency information through text messaging and downloading that information to the central processing unit, this data is then put through a filtration process to allow the most serious road violators and those needing help to be easily retrieved. The information is then transmitted to a subscriber via text message and/or email for corrective action or for dispatching emergency help.

### CROSS-REFERENCE TO RELATED APPLICATIONS

The present application claims the benefit of provisional patent application Ser. No. 61/064,579, filed on Mar. 13, 2008.

### FIELD OF THE INVENTION

The present invention is directed to the field of scanning short message service (SMS) data, also know as “text messaging”, for key words or characters and sending such information to a central processing unit reporting emergency and non-emergency situations. If a keyword is detected, a message is sent to alert the subscriber and if an emergency situation is reported, emergency personnel will be properly dispatched when normal “911” voice calls are unavailable or impractical.

### BACKGROUND OF THE INVENTION

### Text Messaging of Data Using Mobile Devices

Text messaging or “texting” is the common term for the sending of “short” (160 characters or fewer) text messages from mobile phones using the Short Message Service (SMS). It is available on most digital mobile phones and some personal digital assistants with on-board wireless telecommunications. The individual messages which are sent are called “text messages”, or in the more colloquial text speak “texts”.

Common Short Codes (CSC), also known as “short numbers” are special telephone numbers of 4-6 characters and significantly shorter than full telephone numbers, which can also be used to address SMS messages from mobile phones. These numbers are designed to be shorter to read out and easier to remember than normal telephone numbers. While similar to telephone numbers, they are, at the technological level, unique to each operator, although providers generally have agreements to avoid overlaps. Short codes are widely used for value-added services such as television voting, ordering ringtones, charity donations and mobile services. Messages sent to short code numbers are generally billed at a higher rate than a standard SMS.

### Short Message Service Centre (SMSC)

Messages are sent to a Short Message Service Centre (SMSC) which provides a store-and-forward mechanism. It attempts to send messages to their recipients. If a recipient is not reachable, the SMSC queues the message for later retry. When text messages are sent to an SMSC, the cell phone ID of the caller is available and retrieved in addition to time of call.

Website portals such as “transl8it” have supported a community of users to help standardize this text speak by allowing users to submit translations, staking claim with their user handle, or to submit top messages and guess the lingo phrases. The international popularity of this portal resulted in late 2005 the publishing of the transl8it! dxNRE & glosRE (dictionary & glossary) as the world's first, and most complete, SMS and text lingo book.

Some commonly used acronyms on texting are:
2: To or Too
4: For
brb: Be Right Back
gtg: Got To Go
g2g: Got To Go
ttyl: Talk To You Later
idk: I Don't Know
idc: I Don't Care
lol: Laugh(ing) Out Loud
rofl: Rolls On Floor Laugh(ing)
omg: Oh My God

Short message services are developing very rapidly throughout the world. In 2000, just 17 billion SMS messages were sent; in 2001, the number was up to 250 billion, and 500 billion SMS messages in 2004. With carriers charging for each text sent and received, this generated revenues in excess of $50 billion for mobile telephone operators and represented close to 100 text messages for every person in the world.

In the United States, while texting is widely popular among the ages of 10-25 years old, it is increasing among adults and business users as well. According to both the Mobile Marketing Association and Pew Internet & American Life Project Surveys, 40% of US Mobile phone users text. The split by age group is as follows: 13-24's: 80% text, 18-27's 63% text, 28-39's: 31% text, 40-49's: 18% text. The amount of texts being sent in the United States has gone up over the years as the price has gone down to an average of $0.10 per text sent and received. Many providers make unlimited texting available for a lower price.

### Aggressive Drivers

In 1999, the original Road Rage @ RoadRagers.com began. Originally created by a Canadian, Mark Nelson from Winnipeg, Manitoba, this was the first significant website on the subject and is still referenced in the mainstream media. It continues to provide resources on driving style analysis, a road rage quiz, polls, and advice. It also has provided bad driver and road rage reports allowing visitors to vent and contribute to the database of bad drivers by entering their license plate number and other information. RoadRagers.com remains a complementary foundation to the other sites that followed.

In 2000, AboveAverageDriver.com was started as a place to report bad driving by their license plate and vent online. This site allows registered users and unregistered users to report on unsafe drivers around the world but mainly caters to drivers in the US. The site is in its 7th year now, providing a number of statistics to an ever growing community that host a number of reports and search capabilities on good drivers and bad drivers. Today, it has been a foundation for a number of newer websites targeting all types of audiences from teen drivers, parking problems, to attempts to meet that special driver by leaving a message.

In 2006, PlateWire.com was launched by a Washington D.C. programmer, Mark Buckman. This site offers a communication system for drivers to communicate using their license plate as an identifier. Users can “Flag” bad drivers, “Award” good drivers, warn drivers of vehicle hazards, or send a flirtatious “Wink” to make female drivers uncomfortable. PlateWire also offers a toll-free number for members to call in reports. PlateWire has also spawned PlateXchange which enables license plate reporting websites such as PlateWire to share and propagate license plates posted.

In 2007, PlateRage.com was launched. It is an online community that allows users from around the world to vent their road rage and report other license plates in a non-physical, non-violent way. Users can also call in their road rage on a 1-800 number “rage line” that uploads to the site.

These sites require the person filing the report to have access to technology enabling them to access the internet or to make a phone call to someone with access to the internet. The method outline by the present invention utilizes the SMS, or “text message”, to transmit this data by cell phone or other hand held unit and does not require the use of a telephone operator or computer with webaccess.

### Calls Non-Emergency and Emergency

Calls to 911 are well known and documented for their success in providing emergency responders, police, fire and medical, to the scene. However, a recent study of 911 finds that their effectiveness is decreasing due to an increase in calls at a time when there is a decrease in funding for these calls. A study of 911 reported by NBC found:

### Study Finds Nation's 911 Systems Lack Resources and Funding

### Web Editor Rhonda Erskine, Online Content Producer

### Created: Mar. 5, 2008 7:48:02 PM

(NBC)—“We all depend on dialing 911 in an emergency, but did you know the system in place now was designed back when most phones were rotary dial and cell phones weren't even close to being invented? A group that tracks the technology and public safety industries says it's time 911 changed too.

When a gunman opened fire on the campus of Virginia Tech last year students inside the classrooms used their cell phones to text 911 as they hid for their lives. Those messages never got to anyone because the 911 system can't receive texts. Voice calls can get through, but in a big emergency multiple calls often overwhelm the system.

In the 1960s operators would have gotten one or two calls from a pay-phone or landline on any given day. “It is not uncommon today to get 40, 50, 60, 100 calls for a similar incident. So you can understand the strain our 40 year old network is under,” explained Jeff Robertson, executive director of the 911 Industry Alliance.

The Alliance recently ordered an independent evaluation of the nation's system. The conclusion: 911 systems are not keeping up with modern technology. With cell phones, car systems, texting and tracking technology available, the report finds 911 is way behind.

The study also finds finding is shrinking. With less people using landlines, surcharges that once paid for emergency services have been drastically cut. The 911 industry alliance suggests additional surcharges on mobile devices, and they hope to get enough funding to upgrade the system soon. They're urging lawmakers to take the report as a wake-up call before it's too late.”

The present invention addresses the issue of high volume calls and lack of 911's ability to handle text messages. By establishing a SMS or text message code for “911”, “911TEXT” or some other easy to remember number we can have these text messages routed to the proper authorities.

### SUMMARY OF THE INVENTION

### Aggressive Driver Reporting

The rapid proliferation of hand held mobile devices coupled with the increase desire for text messaging of conversations and transmitting data has provided the foundation for this new process for reporting emergency and non-emergency situations such as aggressive drivers, accident reporting and medical emergencies. This invention provides a method allowing instant reporting of these situations by the use of text messages to appropriate authorities. This system can differentiate between minor offenses and dangerous drivers and reports dangerous drivers for public access.

The method and system herein describes a process for transmitting information by the use of SMS, also known as “text messaging” or “texting”. The reason for this system is to allow a method of reporting events instantly with hand held units or cell phones. This method of reporting allows victims the ability to send text messages to a SMSC and eliminate the need to place a voice call or send the report by logging into a website. The text message would be downloaded to a data processing system to allow for filtering, reporting and any other use of this information.

Systems and methods for reporting instances of aggressive driving and other events are well known. These programs to get aggressive drivers off the road, such as call #77 and 800 numbers, simply are not effective for several reasons. The main reason is that drivers do not like to call in and prefer to operate anonymously.

Text messaging, or texting, is the common term for the sending of “short” (160 characters or fewer) text messages from mobile phones using the SMS. It is available on most digital mobile phones and some personal digital assistants with on-board wireless telecommunications. The system of the present invention allows for grouping and classifying text messages to allow for the processing of millions of daily transmissions, thereby eliminating the need for phone operators to answer calls and input information.

Currently law enforcement is the principle method of removing aggressive drivers from the highways. The present invention provides for a more effective, efficient, and user-friendly method of reporting, and, therefore allows millions of regular commuters the ability to simultaneously report aggressive drivers. By doing so, the present invention places these millions of additional “watchdogs” working to report instances of aggressive driving and allows for increased corrective action by appropriate individuals and organizations.

The invention provides a method of using text messaging to transmit data to a central processing unit. With the proliferation of text messaging we have become a society where many, particularly the young, have raised text messaging as the preferred method of communication. Furthermore, text voting has also created an environment where consumers have grown accustomed to the text message rise.

The present invention would send a text message to a registered driver through the use of any communication device, such as a cell phone, hand held unit or computer, that a report has been made regarding the registered driver's driving habits.

Another object of the invention is to send text messages to vehicle owners, or subscribers, when their vehicle has been reported as being driven in an aggressive or dangerous manner.

Another object of this invention is to use this method for other text messaging programs such as the need for information processing and other applications.

Another object of the invention is to filter for chronic calls. After the calls leave the SMSC they are sent to the processing center where they are screened for multiple calls from the same cell phone number and multiple calls reporting the same event.

Another object of the invention is to establish a “mistake” driver filter system allowing for the non-reporting of drivers making a mistake or occasional error as opposed to the habitual aggressive driver.

Another object of the invention is to sort and categorize large volumes of transmitted data to separate speeders, aggressive, discourteous etc. This system allows for high volumes of data to be processed and reported without the need of manually reviewing each text message.

Another object of the invention is to provide a driver history report for individuals, insurance companies and other authorized organizations who desire to review the aggressive driver's history.

Another object of the invention is to search database for reporting of vehicles on law enforcement search lists to locate vehicles that are in the system that law enforcement and other may be on the look out due to criminal activity.

Another object of the invention is to provide insurance risk data for insurance carriers to review in order to reduce insurance liability on aggressive drivers.

Another objective of the invention is to provide state Motor Vehicle Administration, insurance companies and others with filtered history reports on aggressive driving.

### Emergency/Non-Emergency Reporting

This invention also provides a method for law enforcement, medical, fire officials and others to handle text message calls by routing these calls to appropriate authorities. Sending a text message to code “911”, “911 TEXT” or similar SMS code would allow these calls to be processed and immediately diverted to the proper authorities.

Another object of the present invention is to send a text message to emergency personnel as an alternative to 911 in the event that 911 is not available due to high volume of calls. By entering “911TEXT” OR “TEXT911”, or similar characters, these calls will get through during high volume times.

Another object of the present invention is to Text message non-emergency events to authorities for appropriate response. By entering codes such as “911 TEXT” OR “TEXT911” these calls will get through during high volume times.

### BRIEF DESCRIPTION OF THE DRAWINGS

FIG. 1 is a diagram of prior art reporting system;

FIG. 2 is a diagram of the reporting system of the present invention;

FIG. 3 is a diagram of the dedicated SMC text number of the present invention;

FIGS. 4 and 5 show a flow diagram of the present invention; and

### DETAILED DESCRIPTION OF THE INVENTION

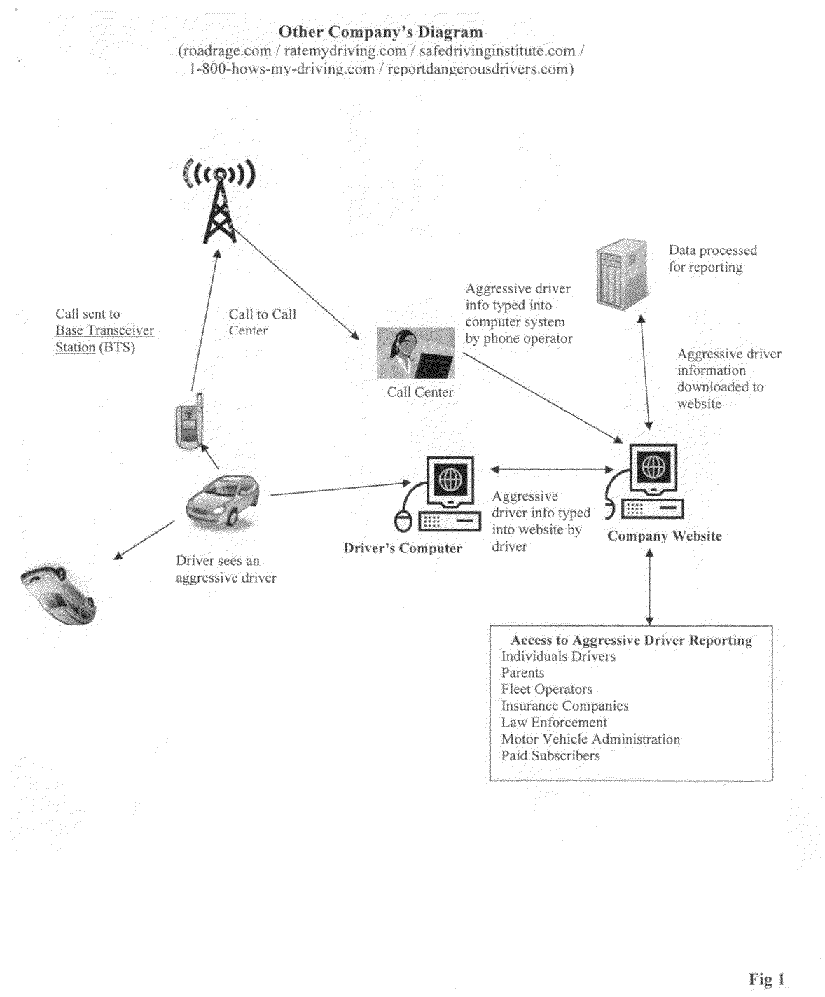

FIG. 1 illustrates a prior art system for reporting aggressive drivers to various individuals or entities, such as the drivers themselves, fleet operators, insurance companies, law enforcement agencies, the Motor Vehicle Administration, as well as paid subscribers. When an individual sees a driver operating in an aggressive or unlawful manner, the driver would utilize a communication device such as a cell phone to relay a voice message to a centralized call center. This information is then entered into a particular website by an operator typing the information received by the person making the call.

Alternatively, if the driver is provided with an onboard computer or laptop, the information verbally reported to the call center would be entered into the driver's computer and transmitted to the company's website which would enter this information therein. The data would then be processed and reported to the appropriate individuals or entities.

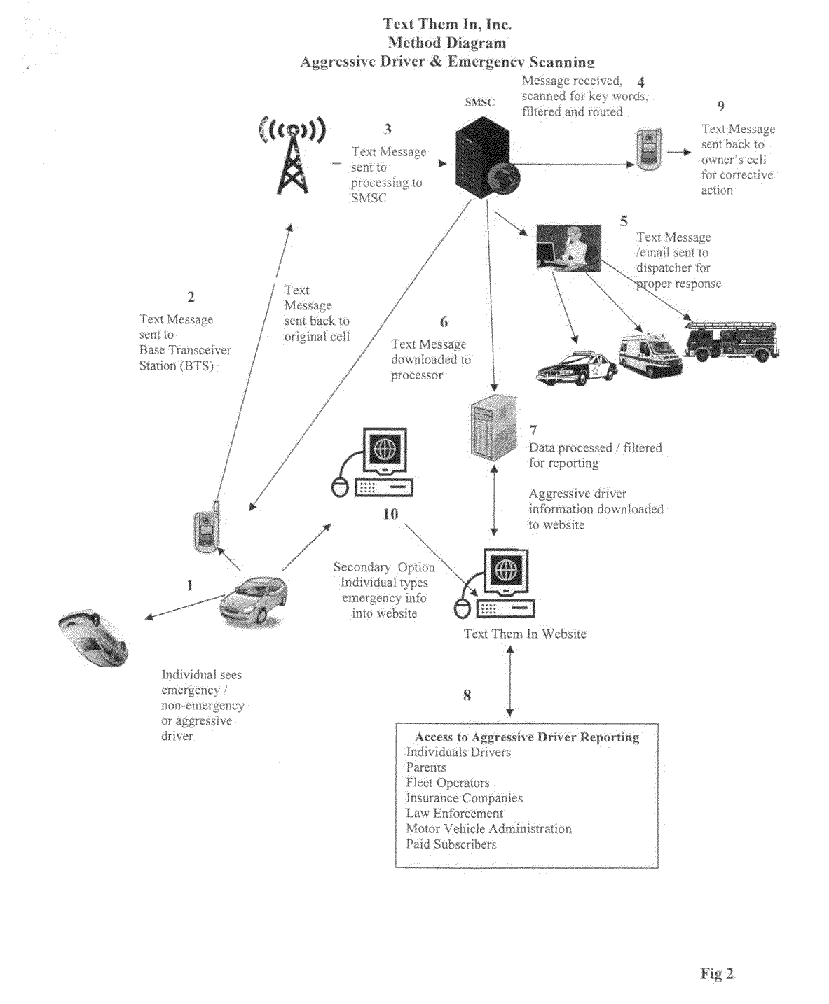

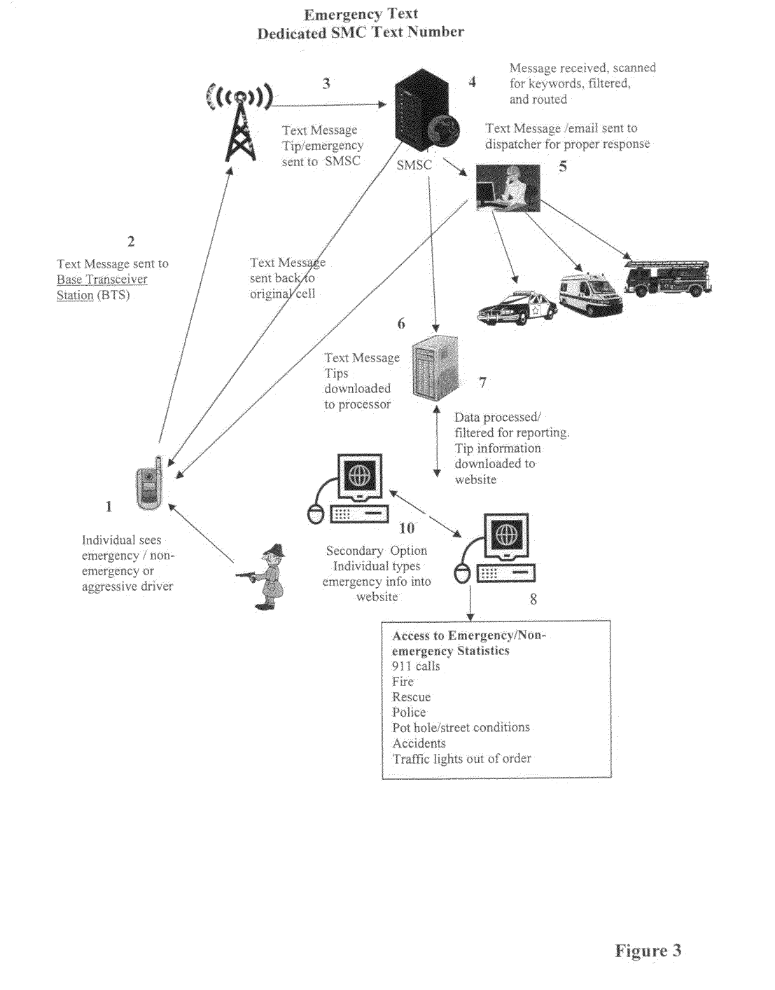

FIG. 2 and FIG. 3 illustrate the teachings of the present invention. This invention would also be utilized to report aggressive and unlawful activities to individual drivers, parents, fleet safety supervisors, insurance companies, motor vehicle administrations, as well as paid subscribers. Once an individual driver becomes aware of an unlawful driving situation or observes a driver operating a vehicle in an aggressive or unsafe manner 1, the individual driver sends a text message 2 directly to a text message center 3 for processing. Additionally, if an individual becomes aware of an emergency situation, the received text message would be routed from a dispatcher 5 to the proper person or agency for the appropriate response, as if the caller dialed 911. The short message service center (SMSC) 4, which receives both emergency and non-emergency text messages, would route the emergency text message to the dispatcher 5 based upon scanning the message for keywords using appropriate software. The dispatcher would then route it to the proper authorities (police, fire, or ambulance, etc.). All text messages would be downloaded to a processor 6 and entered into the text system of the website 7 which would contain information relating to the type of entities shown in box 8.

FIG. 3 illustrates a similar embodiment of the present invention. This illustration provides for a dedicated “text message” number of SMS whereby all text messages directed to subscribers (dispatcher, police, fire, ambulance, etc.) cell phone or email depending on the emergency situation. In this situation, the dispatcher is provided with the cell phone number of the caller, or the company acts as a go-between to facilitate communication and route emergency personnel, thereby providing access to text communication with the caller. This process is used when the ability to make voice calls is not available or impractical.

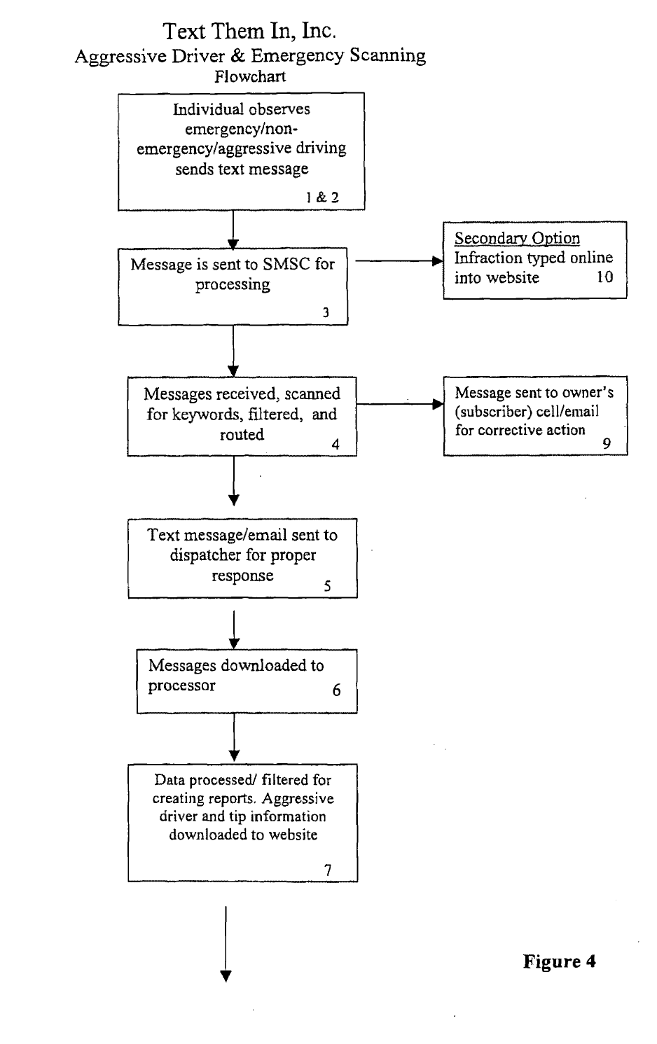

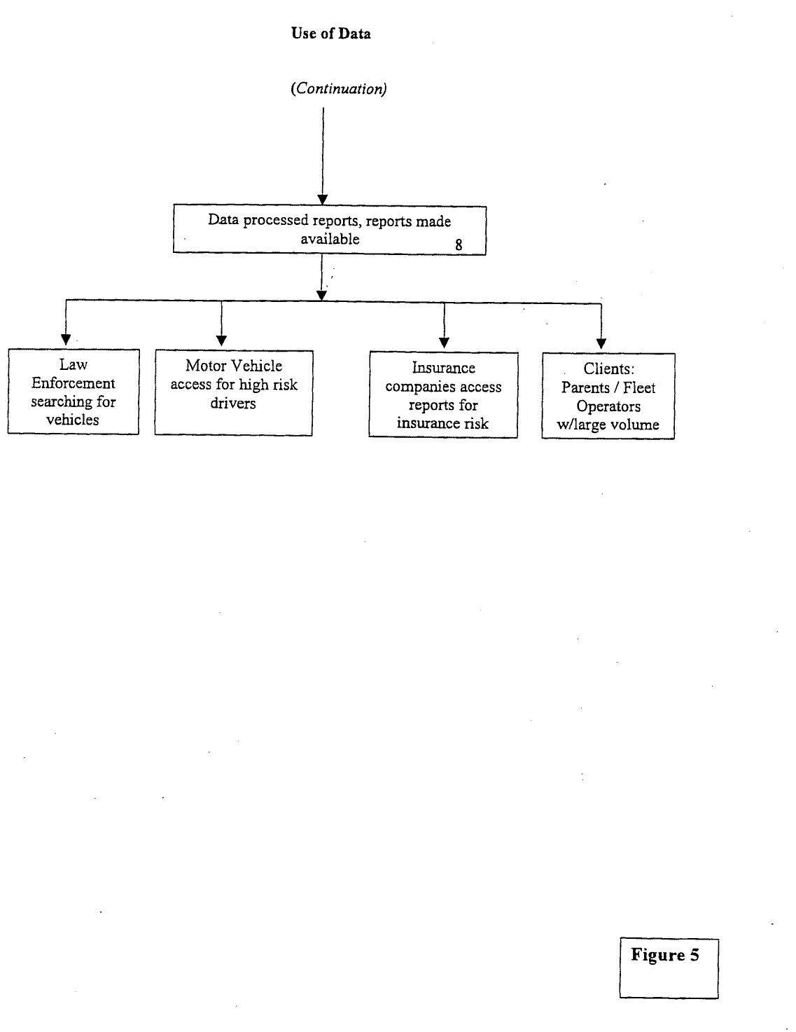

FIGS. 4 and 5 illustrate a flow chart of the present invention illustrated in FIG. 2. Once a driver sees a dangerous situation, they would report this by sending a text message to the SMSC and then would be notified that their report was received 9. A second option 10 is to report the incident at the website through the use of a computer. The report would include the license number, state of the vehicle's tag, location of the incident, description of the incident, as well as other pertinent information. This message is instantly retrieved by a text message call center, which transmits the data to a central location for filtering and reporting the information to a database based upon scanning the message for keywords using appropriate software. A parent, fleet operator, or other individual or entity (subscriber) could register at the centralized database to receive information and reports regarding their children's vehicles or their fleet's vehicles. A text message would be sent to the subscriber's cell phone and/or email when any of their vehicles are reported driving in an aggressive or unsafe manner. Thereafter, the subscriber would contact the driver of that vehicle for corrective action. Likewise, the information sent to the message call center converts the information into reports to be available to the parents, fleet safety supervisors, insurance companies, motor vehicle administrations, and/or law enforcement.

The foregoing description of the specific embodiments will so fully reveal the general nature of the invention that others can, by applying current knowledge, readily modify and/or adapt for various applications such specific embodiments without departing from the generic concept and, therefore, such adaptations and modifications should and are intended to be comprehended within the meaning and range of equivalents of the disclosed embodiment. It is to be understood that the phraseology or terminology employed herein is for the purpose of description and not limitation. Therefore, while the invention has been described in terms of preferred embodiments, those skilled in the art will recognize that the invention can be practiced with modification within the spirit and scope of the present invention.

What is claimed is:

1. A method of sending a message comprising the steps of:
preparing a text message or short message service (SMS);
transmitting said text message or SMS to a central facility; and
scanning keywords within said text message or SMS to route said text message or SMS to an appropriate party.

2. The method in accordance with claim 1, further including the steps of:
observing an occurrence of an action of concern to an observer; and
preparing said text message or SMS based upon said action.

3. The method in accordance with claim 2, wherein said scanning step determines whether an emergency or non-emergency situation exits.

4. The method in accordance with claim 3, further including the step of routing said text message or SMS to the proper emergency personnel when it is determined that an emergency situation exits.

5. The method in accordance with claim 3, further including the steps of:
routing said text message or SMS from said central facility to a processing center having a database when it is determined that a non-emergency situation exits; and
filtering said text message or SMS to determine whether said text message or SMS is legitimate.
